(19) United States
(12) Patent Application Publication
(10) Pub. No.: US 2025/0231278 A1
(43) Pub. Date: Jul. 17, 2025

(54) DETECTION DEVICE AND METHOD OF OPERATING THE SAME

(71) Applicant: SAMSUNG ELECTRONICS CO., LTD., SUWON-SI (KR)

(72) Inventors: Kyungwoo Yoo, Suwon-si (KR); Junseong Kim, Suwon-si (KR); Hoyeol Kim, Suwon-si (KR); Junseuk Suh, Suwon-si (KR); Dooseok Choi, Suwon-si (KR); Joonhoi Hur, Suwon-si (KR)

(21) Appl. No.: 19/010,277

(22) Filed: Jan. 6, 2025

(30) Foreign Application Priority Data
Jan. 11, 2024 (KR) 10-2024-0005016
Apr. 3, 2024 (KR) 10-2024-0045546

(51) Int. Cl. G01S 7/292; G01S 7/288; G01S 13/18; G01S 13/50

(52) U.S. Cl. CPC G01S 7/2927; G01S 7/2883; G01S 13/18; G01S 13/50

(57) ABSTRACT

A detection device includes a Fourier transform processing circuit configured to output first Fourier transform data through range Fourier transform processing on a plurality of pulse signals and output second Fourier transform data through Doppler Fourier transform processing on the first Fourier transform data; a filter characteristic estimation circuit configured to select a plurality of samples corresponding to noise in the second Fourier transform data through a constant false alarm rate (CFAR), obtain noise power data from the plurality of samples, and estimate frequency-dependent filter compensation data based on the noise power data, and a detection circuit configured to compensate the first Fourier transform data based on the filter compensation data and detect a target based on performing the CFAR on the compensated first Fourier transform data.

### CROSS-REFERENCE TO RELATED APPLICATION(S)

This U.S. non-provisional application claims priority under 35 USC § 119 to Korean Patent Application Nos. 10-2024-0005016, filed on Jan. 11, 2024, and 10-2024-0045546, filed on Apr. 3, 2024, in the Korean Intellectual Property Office, the disclosures of which are herein incorporated by reference in their entirety.

### TECHNICAL FIELD

Example embodiments relate to a detection device for detecting an object using radar, and a method of operating the same, and more particularly to a detection device employing Fourier transform processing.

### DISCUSSION OF RELATED ART

In general, filters provided to filter signals may be implemented as a low-pass filter (LPF), a high-pass filter (HPF), a band-pass filter (BPF), a notch filter, etc., depending on a desired frequency passband. Filter characteristics, such as gain and cut-off frequency, may change due to a change in ambient environment, which may include temperature, humidity, pressure, and so forth. In the case of detection devices operational over a variable band or multiple bands, detection performance may deteriorate when filter characteristics change.

### SUMMARY

Example embodiments provide a detection device robust against a change in filter characteristics and a method of operating the same.

According to an example embodiment, a detection device includes a Fourier transform processing circuit configured to output first Fourier transform data through range Fourier transform processing on a plurality of pulse signals and output second Fourier transform data through Doppler Fourier transform processing on the first Fourier transform data; a filter characteristic estimation circuit configured to select a plurality of samples corresponding to noise in the second Fourier transform data through a constant false alarm rate (CFAR), obtain noise power data from the plurality of samples, and estimate frequency-dependent filter compensation data based on the noise power data; and a detection circuit configured to compensate the first Fourier transform data based on the filter compensation data and detect a target based on performing the CFAR on the compensated first Fourier transform data.

According to an example embodiment, a method of operating a detection device includes outputting first Fourier transform data through range Fourier transform processing on a plurality of pulse signals and outputting second Fourier transform data through Doppler Fourier transform processing on the first Fourier transform data, selecting a plurality of samples corresponding to noise in the second Fourier transform data through a constant false alarm rate (CFAR) on the second Fourier transform data, obtaining noise power data from the plurality of samples, estimating frequency-dependent filter compensation data based on the noise power data, compensating the first Fourier transform data based on the filter compensation data, and detecting a target based on performing the CFAR on the compensated first Fourier transform data.

According to an example embodiment, a detection device includes a transceiver configured to transmit and receive a plurality of pulse signals and a processor electrically connected to the transceiver. The processor may be configured to select a plurality of samples corresponding to noise in Doppler Fourier transform data of the plurality of pulse signals through a constant false alarm rate (CFAR) on the Doppler Fourier transform data, obtain noise power data from the plurality of samples, estimate frequency-dependent filter compensation data based on the noise power data, compensate range Fourier transform data of the plurality of pulse signals based on the filter compensation data, and detect a target based on performing the CFAR on the compensated range Fourier transform data.

### BRIEF DESCRIPTION OF DRAWINGS

FIG. 1 is a diagram illustrating a detection device according to example embodiments.

FIG. 2 is a block diagram of a detection device according to example embodiments.

FIG. 3 is a graph illustrating a compensation operation based on fixed filter characteristics.

FIG. 4 depicts graphs illustrating a compensation operation based on adaptively estimated filter characteristics according to example embodiments.

FIG. 5 is a block diagram of a filter characteristic estimation circuit according to example embodiments.

FIG. 6 is a diagram illustrating an operation of obtaining noise power data of burst unit of a detection device according to example embodiments.

FIG. 7 is a 3D graph illustrating a spectrum of Doppler Fourier transform data according to example embodiments.

FIG. 8 is a 3D graph illustrating Doppler Fourier transform data after constant false alarm rate (CFAR) according to example embodiments.

FIG. 9 is a block diagram of a filter compensation data estimation circuit according to example embodiments.

FIG. 10 is a diagram illustrating filter responses based on a frequency according to example embodiments.

FIG. 11 is a flowchart illustrating a method of operating a detection device according to example embodiments.

FIG. 12 is a flowchart illustrating a filter compensation data estimation method of a detection device according to example embodiments.

FIG. 13 is a flowchart illustrating a detection method of a detection device according to example embodiments.

FIG. 14 is a diagram illustrating a range Fourier transform result when there is no compensation for filter characteristics.

FIG. 15 is a diagram illustrating a CFAR result when there is no compensation for filter characteristics.

FIG. 16 is a diagram illustrating a range Fourier transform result when there is compensation for filter characteristics according to example embodiments.

FIG. 17 is a diagram illustrating a CFAR result when there is compensation for filter characteristics according to example embodiments.

### DETAILED DESCRIPTION

Hereinafter, example embodiments will be described with reference to the accompanying drawings.

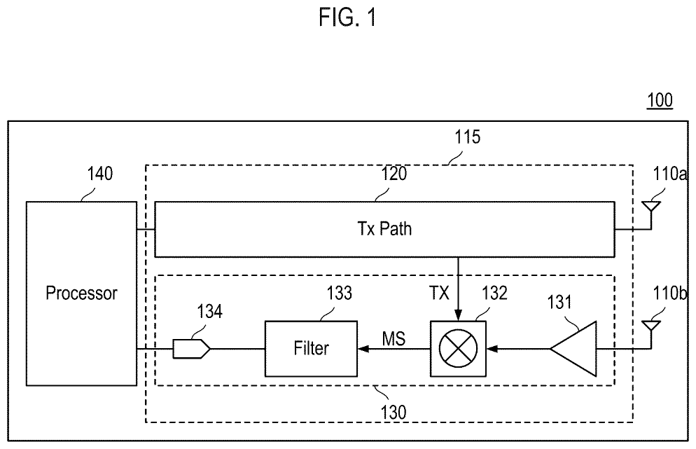

FIG. 1 is a diagram illustrating a detection device, 100, according to example embodiments. The detection device 100 may include a plurality of antennas 110a and 110b, a transceiver 115, and a processor 140.

The plurality of antennas 110a and 110b may include a transmission antenna 110a and a receiving antenna 110. The transmission antenna 110a may transmit a transmit signal generated from a transmission path 120 to free space. The receiving antenna 110b may provide a receive signal, received from an external source, to a receiving path 130. In other examples, the transmission antennas 110a and/or the receiving antennas 110b may each be provided in plural, or a single transceiver antenna may be provided. According to example embodiments, any of the antennas may be or include an array antenna.

The transceiver 115 may be configured to transmit and receive a plurality of pulse signals, and may include the transmission path 120 and the receiving path 130.

The transmission path 120 may convert a digital signal, generated from the processor 140, into a transmit signal in an analog domain, and process the converted transmit signal. The transmission path 120 may include a filter, a mixer, and an amplifier, and/or various other components to convert, generate, and process transmit signals.

According to example embodiments, the transmission path 120 may generate a plurality of pulse signals as transmit signals through an oscillator, not illustrated. For example, each pulse signal may include a continuous wave (CW) signal (within individual pulses) or a frequency modulated continuous wave (FMCW) signal. A signal that is frequency-modulated through FMCW within the time period of a pulse may be referred to as a chirp. For example, a chirp may have a frequency linearly varying through linear frequency modulation (LFM). The chirp may have a sawtooth waveform. Alternatively, the chirp may have a stepped frequency (SF) waveform.

According to example embodiments, the transmission path 120 may continuously transmit a plurality of frequency-modulated chirps. Each of the chirps may be transmitted within a pulse repetition interval (PRI) period.

The receiving path 130 may process an incoming receive signal and convert the processed signal into a receive signal in a digital domain. Similarly to the transmit signal, the receive signal may include a plurality of pulse signals. A single receive pulse signal for a single transmit pulse signal may be received through the receiving path 130 after a round-trip time (the time taken for a transmit signal to be reflected off an object and received by the receiver as the receive signal).

According to example embodiments, the receiving path 130 may include a low-noise amplifier (LNA) 131, a mixer 132, a filter 133, and an analog-to-digital converter (ADC) 134. The low-noise amplifier 131 may perform low-noise amplification on a receive signal and provide the low-noise-amplified signal to the mixer 132. The mixer 132 may mix the transmit signal and the receive signal received from the receiving path 130, and output a mixing signal MS. The mixing signal MS may also be referred to as an IF signal, and may have a frequency corresponding to a difference between a frequency of the transmit signal and a frequency of the receive signal. The frequency of the mixing signal MS may be referred to as a beat frequency.

The filter 133 may be configured to filter the mixing signal MS provided from the mixer 132. For example, the filter 133 may be implemented as a low-pass filter (LPF), a high-pass filter (HPF), or the like, to filter a specific band of the mixing signal MS. For example, when the detection device 100 is configured to detect a near-range target or ultra-near-range target, the filter 133 may be implemented as an HPF to reduce an effect of a low frequency leakage signal.

The filter 133 may be basically designed to have filter characteristics such as gain and cut-off frequency, but the filter characteristics may vary depending on a change in ambient environment, which may include temperature, humidity, pressure, etc. A noise level of the filtered signal may also vary over time and frequency and as a function of the ambient environment. The filtered signal may be transformed from an analog domain to a digital domain through ADC 134 and then routed to the processor 140.

The processor 140 may process a digital signal including information to be transmitted, or process a receive signal.

According to example embodiments, the processor 140 may perform various operations to detect a target from the receive signal. For example, the processor 140 may detect a target through constant false alarm rate (CFAR) processing for the receive signal. CFAR is an algorithm for constantly setting a false alarm determined as if a reflection signal for a target is present although the reflection signal is absent. The false alarm may be due to spurious noise that exceeds a threshold value. The threshold value may be allowed to adaptively change in correspondence with a change in average noise level, which may be due to a change in ambient environment. Thus, CFAR may allow a target to be detected from the receive signal with a desired or required probability of false alarms. For example, the processor 140 may set the threshold value higher when the noise level is high, and set the threshold value lower when the noise level is low. Thus, the threshold may be raised or lowered to maintain a constant probability of false alarms. For example, if the threshold is set too low, more real objects will be detected but at the expense of more false alarms. Conversely, if the threshold is set too high, there will be less false alarms, but fewer objects will be detected (too many will remain undetected). Thus, a constant probability of false alarms is desirable, where the constant probability may be set according to the application.

In CFAR, false alarms are likely to occur less frequently as the noise level becomes more constant over a frequency band of operation. Accordingly, the processor 140 may estimate the filter characteristics and compensate for the noise level based on inverse characteristics of the estimated filter characteristics.

According to example embodiments, when there is a change in the ambient environment, the processor 140 may estimate changed filter characteristics correlated with the change in ambient environment. The estimation of the filter characteristics may be performed using a plurality of pulse signals corresponding to the receive signal. For example, the processor 140 may estimate the filter characteristics using a signal that is also used to detect a target. Unless otherwise specifically mentioned below, a pulse signal processed by the processor 140 will refer to a signal transformed into a digital domain through the ADC 134 after the receive signal is mixed through the mixer 132.

The processor 140 may obtain range Fourier transform data and Doppler Fourier transform data by performing a range Doppler Fourier transform on a plurality of pulse signals. In the Doppler Fourier transform data, there is a peak value of magnitude at a range and a Doppler value corresponds to a location corresponding to a target. Further, a value based on a noise level is present in a region in which the target is absent.

The processor 140 may perform CFAR processing on the Doppler Fourier transform data. The processor 140 may select a plurality of samples corresponding to noise from the Doppler Fourier transform data, based on a result of the CFAR processing.

The processor 140 may obtain noise power data from the plurality of samples, and estimate filter compensation data as a function of frequency based on the obtained noise power data. According to example embodiments, the processor 140 may calculate a variance value of the plurality of samples. When a noise level is assumed to be zero-mean, the variance value may be regarded as noise power, so that the processor 140 may obtain the calculated variance value as noise power data.

The processor 140 may take an inverse of the obtained noise power data and estimate a reciprocal as filter compensation data. The noise power data may be defined for each frequency. Therefore, the noise power data may be regarded as data that replicates frequency-dependent response characteristics of a filter. As a result, the filter compensation data estimated as the inverse of the noise power data may inversely compensate for the response characteristics of the filter.

According to example embodiments, the processor 140 may estimate the filter compensation data for a plurality of bursts to increase the reliability of the filter compensation data. Each of the plurality of bursts may include a plurality of pulse signals. For example, if the number of pulse signals is M and the number of bursts is L (where M and L are positive integers), then a receiving circuit may estimate the filter compensation data for L bursts.

The processor 140 may detect a target based on compensating range Fourier transform data based on the estimated filter compensation data, and perform CFAR processing on the compensated data. When there is no compensation for changed response characteristics of a filter, a noise level may be present across range bins of the range Fourier transform data. When there is a cutoff frequency of the filter within the frequency range to be detected, different levels of noise may be present for each range bin. Thus, it may be difficult to ensure a constant noise level when the inverse compensation of the filter characteristics is not performed based on the changed filter characteristics. As a result, it may be difficult to perform at least CFAR on a range axis.

When the filter compensation data according to the changed response characteristics of the filter 133 is used for compensation, the range Fourier transform data may also have a constant noise level for each range bin. Accordingly, CFAR for the range Fourier transform data, rather than Doppler Fourier transform data, may also be performed.

As a result, the detection device 100 according to the above-described embodiments may estimate the changed response characteristics of the filter 133 and perform inverse compensation through use of the estimated filter characteristics to have detection performance robust against a change in filter characteristics. In addition, CFAR may be performed on the range Fourier transform data, rather than Doppler Fourier transform data, during the detection process, so that the amount of calculation may be reduced.

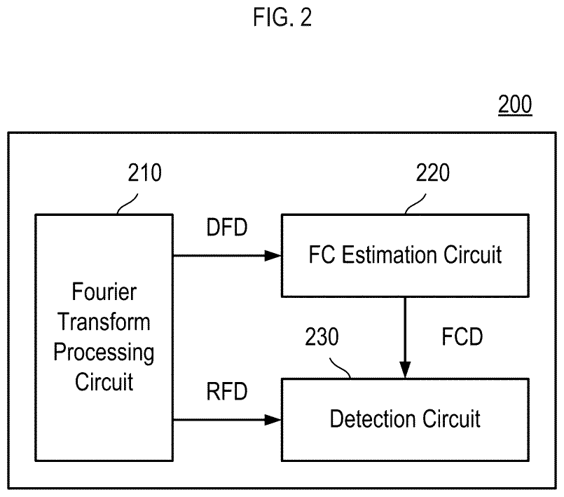

FIG. 2 is a block diagram of a detection device, 200, according to example embodiments. The detection device 200 may be implemented as processing circuitry executing instructions within the processor 140 of FIG. 1. The detection device 200 may include a Fourier transform processing circuit 210, a filter characteristic estimation circuit 220, and a detection circuit 230. At least a portion of the Fourier transform processing circuit 210, the filter characteristic estimation circuit 220, and the detection circuit 230 may be configured to perform a portion of the functions or operations performed by the processor 140 described above in FIG. 1.

The Fourier transform processing circuit 210 may be configured to perform “range Fourier transform” processing and “Doppler Fourier transform” processing. For example, the Fourier processing circuit 210 may perform Fourier transform processing such as running a fast Fourier transform (FFT) or a discrete Fourier transform (DFT).

According to example embodiments, the Fourier transform processing circuit 210 may obtain range Fourier transform data RFD represented as a range-dependent spectrum through range Fourier transform on a plurality of pulse signals. In the range Fourier transform data RFD, a peak appears in a range in which a target is present. The Fourier transform processing circuit 210 may perform Doppler Fourier transform on the range Fourier transform data RFD to obtain Doppler Fourier transform data DFD (also referred to as range Doppler Fourier transform data) represented as a range Doppler spectrum. For example, the Fourier transform processing circuit 210 may perform a Fourier transform along a pulse axis on each range bin of the range Fourier transform data RFD, obtained for each pulse, to perform Doppler Fourier transform. This is sometimes referred to as two dimensional (2D) FFT processing.

Accordingly, the Doppler Fourier transform data DFD is represented as a spectrum on a range axis and a Doppler axis.

The filter characteristic estimation circuit 220 may estimate response characteristics of a filter (for example, the filter of FIG. 1). For example, the filter characteristic estimation circuit 220 may perform CFAR processing on the Doppler Fourier transform data DFD. Through CFAR, a determination may be made as to whether a target is present for a plurality of pulse signals. The filter characteristic estimation circuit 220 may perform CFAR on the Doppler Fourier transform data DFD, rather than the range Fourier transform data RFD, because it may be difficult to accurately determine the filter characteristics for each range bin.

The filter characteristic estimation circuit 220 may perform CFAR for a plurality of Doppler bins for each range bin on the Doppler Fourier transform data DFD.

The filter characteristic estimation circuit 220 may select a plurality of samples corresponding to noise from the Doppler Fourier transform data DFD through CFAR.

An example is provided in which there are M pulse signals (pulses), the number of Fourier samples for each pulse is N, an index of a range bin is n (where N and n are positive integers), and the maximum number of targets present in an nth range bin is Na (where Na is a positive integer). In the Doppler Fourier transform data DFD, an index of a pulse signal may be regarded as a Doppler bin, and a Fourier sample may be regarded as a range bin. Accordingly, it is considered that up to Na Doppler bins represent a target in the M Doppler bins.

If an example is provided in which M is probabilistically significantly larger than Na and only noise levels are present in (M-Na) Doppler bins, then K Doppler bins (where K is a positive integer and has a smaller size than M-Na) are extracted for each range bin and K noise levels may be present for each range bin.

Accordingly, the filter characteristic estimation circuit 220 may select K Doppler bins (for example, a plurality of samples) as noise levels from the Doppler Fourier transform data DFD and obtain noise power data using the selected samples.

According to example embodiments, the filter characteristic estimation circuit 220 may exclude samples, in which a detection flag indicates a specific value, from the Doppler Fourier transform data DFD through CFAR. The filter characteristic estimation circuit 220 may select a plurality of samples, among the remaining samples other than the excluded samples.

According to example embodiments, the filter characteristic estimation circuit 220 may calculate a variance value of a plurality of samples and obtain the calculated variance value as noise power data. For example, the filter characteristic estimation circuit 220 may calculate the square of an absolute value of each sample and sum the calculated squares. Then, the filter characteristic estimation circuit 220 may calculate an average of sum values based on the summation to obtain a variance value for noise levels, based on the plurality of samples. As described above, when the noise level is zero-mean, the variance value is regarded as noise power, so that the variance value may act as the noise power data.

Considering that the sample is a Doppler bin, the noise power data may be defined for each range. The range bin may be replaced with a frequency of the mixing signal (IF signal), so that the noise power data may be defined as data representing the noise power for each frequency.

Ultimately, the filter characteristic estimation circuit 220 may estimate the filter compensation data FCD according to frequency based on the obtained noise power data. The filter characteristic estimation circuit 220 may calculate an inverse of the noise power data and estimate the calculated inverse as the filter compensation data FCD. For example, the filter compensation data FCD may be data used to inversely compensate for the filter response having changed filter characteristics.

According to example embodiments, the filter characteristic estimation circuit 220 may update the filter compensation data FCD by applying a weight to each of reference filter compensation data and the filter compensation data FCD. The reference filter compensation data may be data estimated before a plurality of pulse signals, a target of filter estimation, are transmitted or received.

The detection circuit 230 may compensate for the range Fourier transform data RFD based on the filter compensation data FCD estimated by the filter characteristic estimation circuit 220. For example, an elementwise product of the range Fourier transform data RFD and the filter compensation data FCD may be performed to compensate for a noise level. For example, the detection circuit 230 may perform compensation using the range Fourier transform data RFD, rather than the Doppler Fourier transform data DFD, to perform CFAR on the range Fourier transform data RFD. This is because the noise level also appears uniformly in the range Fourier transform data RFD through the compensation.

Thereafter, the detection circuit 230 may detect a target using CFAR processing on data compensated according to the compensation. For example, when a detection flag output as a result of CFAR indicates a specific value (for example, logic high), the detection circuit 230 may determine that a target has been detected.

The detection device 200 according to the above-described embodiments may detect a target in consideration of the changed filter characteristic by adaptively estimating the filter compensation data FCD. For example, the detection device 200 may compensate for the noise level using the estimated filter compensation data FCD to allow CFAR to be performed even on the range Fourier transform data RFD. Accordingly, the amount of calculation in the detection operation may be reduced.

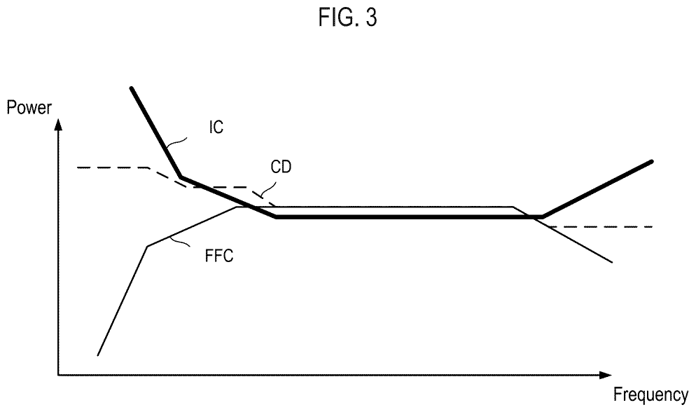

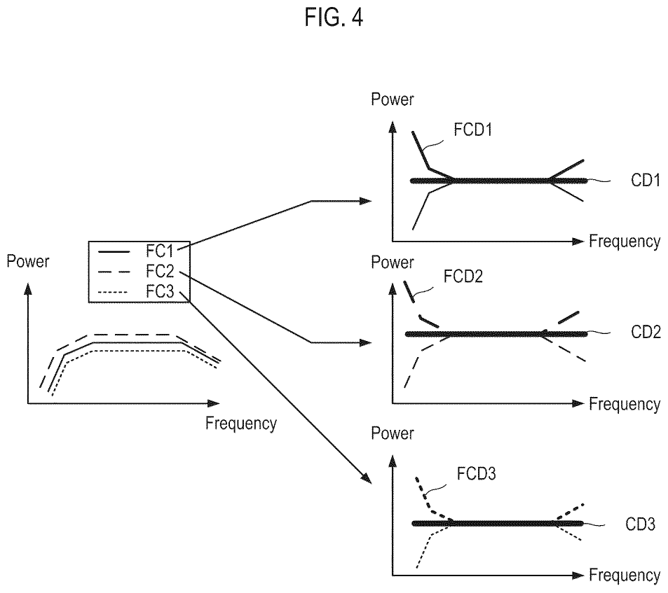

FIG. 3 is a graph illustrating a compensation operation based on fixed filter characteristics (passband power (gain) vs. frequency). FIG. 4 depicts graphs illustrating a compensation operation based on adaptively estimated filter characteristics according to example embodiments.

Referring to FIG. 3, when noise level compensation is performed based on fixed filter characteristics, the noise level for the inverse characteristic (IC) of the fixed filter characteristic (FFC) can be compensated to a predetermined level. However, if the filter characteristic changes, it may be difficult to compensate to reduce a noise level to a predetermined level based on fixed filter characteristics FFC or IC. As a result, the compensated data CD may have predetermined noise power in a specific frequency band and fluctuating noise power at other frequency bands, as illustrated in the drawing.

Accordingly, it may be difficult to perform CFAR on the compensated data CD having noise power fluctuating with frequency, as illustrated in FIG. 3.

Referring to FIG. 4, when filter characteristics are adaptively estimated according to example embodiments, compensated data CD1 to CD3 may all have a predetermined level of noise power.

When there are changed filter characteristics FC1 to FC3 from a previous filter characteristic (not shown), the detection device 200 may estimate each of the changed filter characteristics FC1 to FC3. The change in filter characteristics may be assumed due to a detected change in noise level, which in turn may be due to a change in environmental conditions. The detection device 200 may estimate an inverse of the estimated filter characteristic as filter compensation data FCD1 to FCD3 and compensate for the noise power using the filter compensation data FCD1 to FCD3 corresponding to the changed filter characteristic. Accordingly, even when the changed filter characteristics FC1 to FC3 have different noise powers for each frequency, all of the noise powers may be compensated to attain a predetermined noise level over a frequency range of interest. Note that the phrase “filter characteristics FC1 to FC3 have different noise powers for each frequency” may mean that when the same level of noise is input to a filter having each of the filter characteristics FC1 to FC3 at different times due to different environmental conditions or the like, the output noise power at any of the frequencies is different among the cases of FC1 to FC3.

As a result, the detection device 200 may detect a target by applying CFAR to the range Fourier transform data having a predetermined level of noise power.

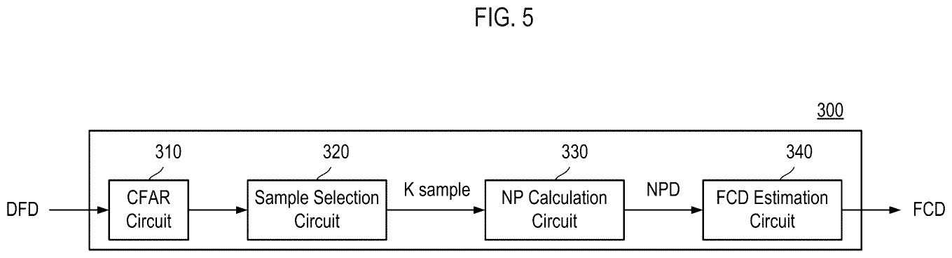

FIG. 5 is a block diagram of a filter characteristic estimation circuit according to example embodiments.

Referring to FIG. 5, a filter characteristic estimation circuit 300 (an example of the FC estimation circuit 220 of FIG. 2) may include a CFAR circuit 310, a sample selection circuit 320, a noise power data calculation circuit 330, and a filter compensation data estimation circuit 340.

The CFAR circuit 310 may perform CFAR on Doppler Fourier transform data DFD. In Doppler Fourier transform data DFD, a region corresponding to noise and a region corresponding to a target may be identified through CFAR. A result of identification may be a detection flag indicating whether a target is detected. The detection flag may indicate a specific value (for example, logic high) in regions having peak levels in the Doppler Fourier transform data DFD, and may indicate 0 (for example, logic low) in the remaining regions. The corresponding region is likely to present a target.

The sample selection circuit 320 may select K samples (where K is a positive integer) from M Doppler bins for each range bin in the Doppler Fourier transform data DFD. For example, K samples may be selected from M Doppler bins for an nth range bin. The selected K samples may correspond to a noise level.

According to example embodiments, the sample selection circuit 320 may exclude samples from the Doppler Fourier transform data DFD in which a detection flag output through the CFAR circuit 310 indicates a specific value. For example, the sample selection circuit 320 may select a plurality of samples from the remaining samples except for the excluded samples. Accordingly, regions in which a target is highly likely to be present are excluded from the samples, so that more accurate filter compensation data FCD may be estimated.

The noise power data calculation circuit 330 may calculate noise power data NPD from the selected plurality of samples for each frequency.

The noise power data calculation circuit 330 may calculate the square of an absolute value of each sample and sum the calculated squares. The noise power data calculation circuit 330 may calculate an average of sum values as a variance value for the plurality of samples and obtain the calculated variance value as noise power data NPD. For example, when the noise power data calculation circuit 330 calculates the variance value for M pulse signals, the noise power data calculation circuit 330 may calculate a value, obtained by dividing the sum value by K, as the variance value.

The filter compensation data estimation circuit 340 may calculate an inverse of the calculated noise power data NPD and estimate the calculated inverse as the filter compensation data FCD. For example, when NS elements (where NS is a positive integer) of the noise power data NPD are calculated for the nth range bin, the filter compensation data estimation circuit 340 may take an elementwise reciprocal for each element and estimate the taken reciprocal as the filter compensation data FCD.

The filter characteristic estimation circuit 300 according to the above-described embodiments may calculate noise power data NPD from the Doppler Fourier transform data DFD for M pulse signals and estimate filter compensation data FCD from the calculated noise power data NPD. Accordingly, instead of predetermined filter compensation data, adaptively estimated filter compensation data may be used for detection.

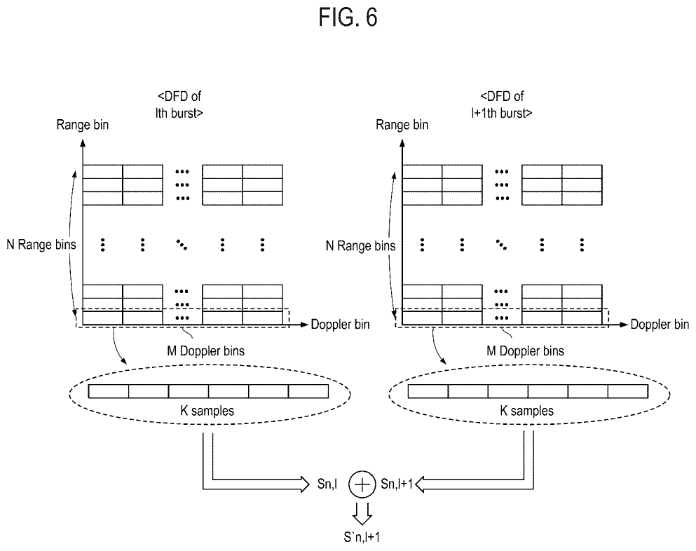

Hereinafter, the operation of a detection device according to example embodiments will be described with reference to FIGS. 6 to 8.

FIG. 6 is a diagram illustrating an operation of obtaining noise power data of a burst unit (“burst”) of a detection device 100 according to example embodiments. As shown in FIG. 6, the detection device 100 may transmit and receive M pulse signals through the transmission and receiving paths of FIG. 1 to perform detection. The M pulse signals may correspond to a single burst unit. Transmitting and receiving L bursts by the detection device 100 may refer to repeating the transmission and reception of the M pulse signals L times. Similarly, obtaining noise power data for the L bursts may refer to repeating an operation of obtaining noise power data for M pulse signals L times.

Among the L bursts, an Ith burst (where I is a positive integer less than or equal to L) and an I+1-th burst are now described. As described above, Doppler Fourier transform data DFD may be represented by Doppler bins and range bins. Similarly, M Doppler bins are provided for the M pulse signals. In addition, N range bins (or Fourier samples) exist for each Doppler bin.

The detection device 100 may select K samples from M Doppler bins for each range bin. For example, the K samples may be selected from M Doppler bins for an nth range bin. The detection device may calculate the square of a value of each of the K samples, selected for each range bin, for the Ith burst and sum the square values. If a sum value for the Ith burst is defined as a first sum value (Sn,I) and a sum value for the I+1-th burst is defined as a second sum value (Sn,I+1), the detection device 100 may update a value, obtained by adding the first sum value (Sn,I) to the second sum value (Sn,I+1), as a new second sum value (S′n,I+1).

The detection device 100 may obtain a final sum value for the L bursts by repeating the update of the sum value for each burst. The detection device 100 may obtain a value, obtained by dividing a sum value, in which the update has been completed, by K*L, as noise power data. For example, a variance value of noise power values corresponding to the K samples may be the noise power data.

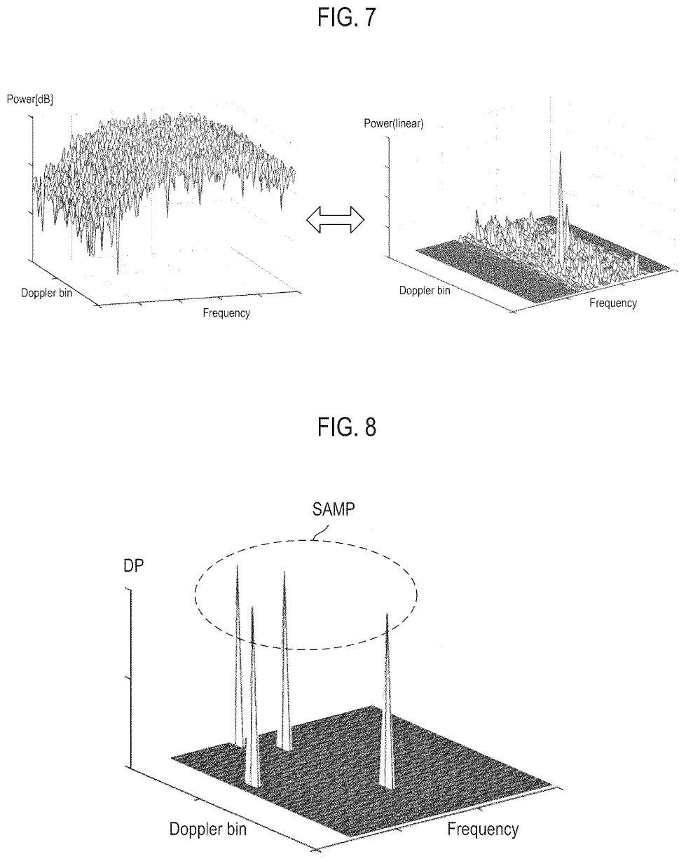

FIG. 7 is a three-dimensional (3D) graph illustrating a spectrum of Doppler Fourier transform data according to example embodiments.

Referring to FIG. 7, as can be seen, a noise power spectrum (dB scale) may have different values vs. frequency. For example, when the filter has a cutoff frequency, the noise power may not exhibit a predetermined level before the cutoff frequency. Accordingly, the detection device 100 may estimate frequency-dependent filter characteristics to compensate the noise power to attain a predetermined level over a frequency band of interest.

However, as seen from a noise power spectrum illustrated with a linear scale, peaks are present in some regions. The peaks may be present due to noise as well as a target. Accordingly, the peaks should be removed from Doppler Fourier transform data.

FIG. 8 is a 3D graph illustrating Doppler Fourier transform data after CFAR according to example embodiments.

Referring to FIG. 8, a detection device 100 may perform CFAR on Doppler Fourier transform data to select a plurality of samples. After CFAR, a detection flag DP indicating whether a target has been detected is output. Then, the detection device may select a plurality of samples, among remaining samples except for samples SAMP in which a detection flag DP indicates a specific value, from the Doppler Fourier transform data. The detection device may calculate noise power data for each frequency from the plurality of selected samples. Ultimately, by removing peaks that may correspond to a target according to the above-described embodiments, a more accurate calculation of noise power data may be achieved.

A signal reflected on a target may be included in K samples selected through the sample selection circuit 320, but a sample corresponding to the reflected signal is a value that has already been determined to be a noise level, and thus may be sufficiently regarded as a noise level. Accordingly, even when the reflected signal is included in the sample, it may not be determined that detection performance deteriorates.

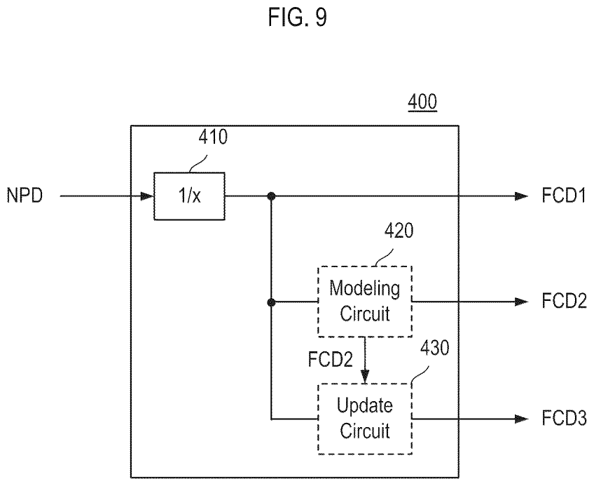

FIG. 9 is a block diagram of a filter compensation data estimation circuit according to example embodiments.

Referring to FIG. 9, a filter compensation data estimation circuit 400 is an example of the FCD estimation circuit 340 of FIG. 5, and may include an inverse transform circuit 410. In some embodiments, the filter compensation data estimation circuit 400 may include a modeling circuit 420 and/or an update circuit 430.

The inverse transform circuit 410 may take a reciprocal of noise power data and may obtain the reciprocal as filter compensation data. For example, when the noise power data is defined as [p_{1,n}, p_{2,n}, . . . , p_{Ns,n}]_{T} (where each element is a noise power value for an nth range bin), the filter compensation data output by the inverse transform circuit 410 may be defined as [1/p_{1,n}, 1/p_{2,n}, . . . , 1/p_{Ns,n}]^{T}. For ease of description, data output through the inverse transform circuit 410 of FIG. 9 is referred to as first filter compensation data FCD1.

The modeling circuit 420 may model a function that reflects the first filter compensation data FCD1 obtained through the inverse transform circuit 410. The modeling circuit 420 may model a function based on a fitting algorithm, such as least square, linear regression, or polynomial fitting, and output the second filter compensation data FCD2 according to the modeling. The modeled function may have the same slope as a filter characteristic function before the filter characteristics are changed. The modeled function may be a combination of a plurality of linear equations.

When filter characteristics that vary with an ambient environment are changed, a cutoff frequency may move in the frequency domain or the filter gain may change. However, the slope of the filter response may remain almost unchanged. Therefore, the modeling circuit 420 according to example embodiments may estimate the variable A and/or f0 defined in the expression filter′(f)=A·filter(f−f₀), based on the first filter compensation data FCD1. Here, filter(f) is a filter response function before the change, and filter′(f) is a filter response function after the change. For example, A and f0, real numbers, may be a magnitude variation coefficient and a frequency variation coefficient of the filter response function after the change, respectively.

The update circuit 430 may perform an update of the filter compensation data based on the first filter compensation data FCD1 or the second filter compensation data FCD2. The update may result in the third filter compensation data FCD3 being output from the update circuit 430.

The update circuit 430 may perform an update by applying a weight to the first filter compensation data FCD1 or the second filter compensation data FCD2. For example, when the filter compensation data before the update (which may also be referred to as reference filter compensation data) is defined as Fₚᵣₑᵥ and the filter compensation data after the update (for example, the third filter compensation data FCD3) is defined as F_{new}, the update circuit 430 may perform an update based on F′_{new}=(1−αFₚᵣₑᵥ+αF_{new}, where F′_{new} is newly updated compensation data based on α, α is a weight and 0<α≤1. The weight may be set to a selected value among various values.

According to example embodiments, the weight may be set to a relatively small value when a weight of the filter compensation data before the update is intended to increase. In addition, the weight may be set to a relatively high value when the weight of the filter compensation data before the update is intended to decrease.

According to example embodiments, the update circuit 430 may also update the above-mentioned f0 based on f_{0,new}=(1−α)f_{0,prev}+αf_{0,new}, as

f′_{0,new}=(1−α)f_{0,prev}+αf_{0,new}, where f′_{0,new} is newly updated f0 based onα.

When an update is performed by applying a weight through the update circuit 430 according to the above-described example embodiments, existing frequency response characteristics may be appropriately taken into consideration, so that an effect of errors that may occur in the calculation of the frequency response characteristics after the change may be reduced.

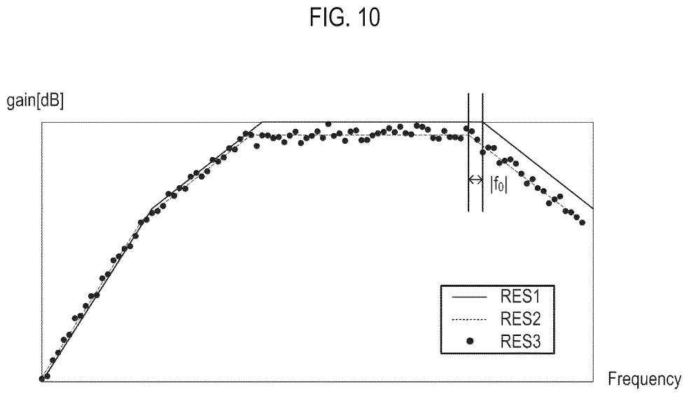

FIG. 10 is a graph illustrating filter responses as a function of frequency according to example embodiments.

FIG. 10 illustrates a first filter response RES1, which is a filter response before filter characteristics are changed; a second filter response RES2, which is a filter response after the filter characteristics are changed; and a third filter response RES3, which is filter compensation data estimated according to the above-described example embodiments.

As illustrated in the drawing, slopes of linear functions forming the first filter response RES1 and the second filter response RES2 are the same. Therefore, the filter compensation data estimation circuit according to example embodiments (for example, FIG. 9) may estimate the frequency variation coefficient f0 and output second filter compensation data based on the estimated f0. In addition, the filter compensation data estimation circuit may update the estimated f0 based on a weight. As illustrated in FIG. 10, the frequency variation coefficient f0 may represent a frequency offset between the frequencies at which the first and second filter responses RES1 and RES2 begin to slope downward following a flat bandpass region.

The filter compensation data estimation circuit according to the above-described example embodiments may estimate the filter compensation data more robustly through a weight-based update.

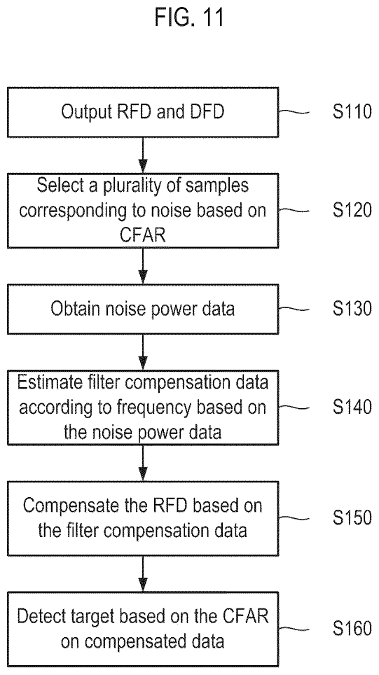

FIG. 11 is a flowchart illustrating a method of operating a detection device (e.g., 100 of FIG. 1) according to example embodiments.

Referring to FIG. 11, in operation S110, the detection device may perform a range Fourier transform on a plurality of pulse signals to output range Fourier transform data RFD, and perform Doppler Fourier transform on the range Fourier transform data RFD to output Doppler Fourier transform data DFD. For example, each pulse signal may correspond to a mixing signal (or an IF signal) of a transmit signal and a receive signal.

The detection device may perform range Fourier transform on each mixing signal to obtain range Fourier transform data RFD defined in a range bin domain. The detection device may thereafter perform Doppler Fourier transform on each range bin to obtain Doppler Fourier transform data defined in the range bin domain and a Doppler bin domain.

In operation S120, the detection device may select a plurality of samples corresponding to noise from the Doppler Fourier transform data DFD through CFAR processing on the Doppler Fourier transform data DFD. For example, the detection device may perform CFAR on the Doppler Fourier transform data DFD for each range bin. According to example embodiments, in operation S120, the plurality of samples may be selected from among the Doppler Fourier transform data DFD except for those detected as a target (for example, a sample in which a detection flag indicates a specific value).

In operation S130, the detection device may obtain noise power data from the plurality of samples. According to example embodiments, the detection device may calculate a variance value of the noise power from the plurality of samples and obtain the calculated variance value as noise power data.

In operation S140, the detection device may estimate frequency-dependent filter compensation data based on the noise power data. For example, the detection device may estimate an inverse of the noise power data as the filter compensation data. The noise power data may have a plurality of elements for each range bin, and a reciprocal of each element may be estimated as an element of the filter compensation data.

In operation S150, the detection device may compensate for the range Fourier transform data RFD based on the filter compensation data. The range Fourier transform data RFD to be compensated may be obtained by performing range Fourier transform on a specific pulse. The specific pulse may be a signal for which the detection device intends to detect a target, and may be a chirp signal transmitted and received toward the target.

According to example embodiments, the compensation may be performed through an elementwise product of the filter compensation data and the range Fourier transform data RFD.

In operation S160, the detection device may detect a target based on performing CFAR on data compensated based on the compensation. Operation S160 may be performed on the range Fourier transform data RFD compensated through operation S150, rather than the Doppler Fourier transform data DFD. When a detection flag indicates a specific value through the CFAR, it may be determined that a target has been detected.

Ultimately, the operating method according to the above-described example embodiments may adaptively estimate and compensate for filter characteristics before operations of detecting a target (e.g., operations S150 and S160) to achieve a robust detection even in a changed environment. For example, CFAR for target detection may be directly applied to the range Fourier transform data RFD, thereby increasing processing speed.

In the above-described example embodiments, the detection device may increase the number of a plurality of pulse signals to increase the number of selected samples. The accuracy of the obtained noise power data may be improved.

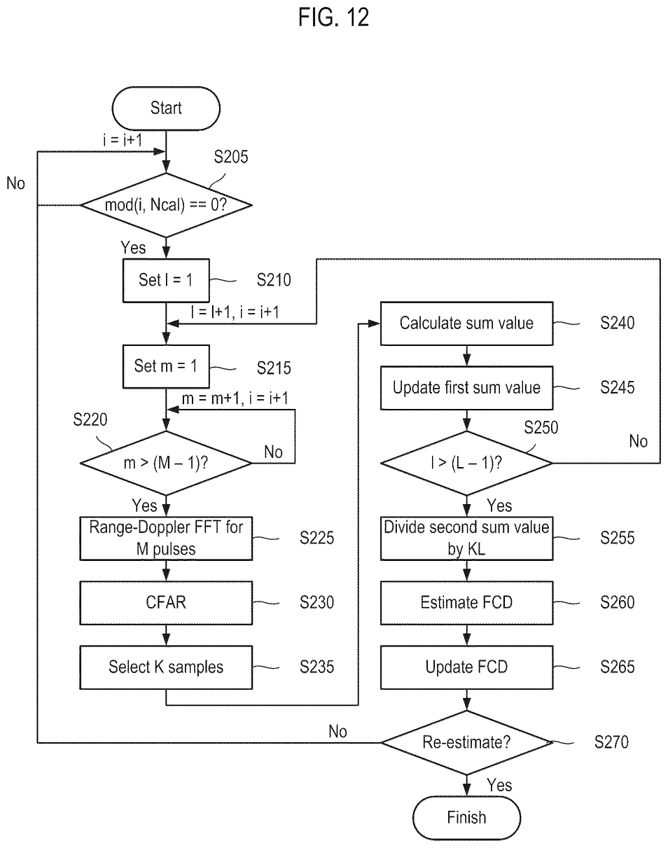

FIG. 12 is a flowchart illustrating a filter compensation data estimation method of a detection device according to example embodiments.

Referring to FIG. 12, an example is provided in which an index i of all pulse signals, a burst index I, and an index m of M pulse signals for a single burst are set to 1. In addition, M, K that is the number of a plurality of samples, L that is the number of bursts, and Ncal that is the number of all pulse signals may be set, and may defined as follows: Ncal>M>K. In addition, reference filter compensation data may be set to Fref, and Pn that noise power data for an nth range bin may be set to 0.

According to example embodiments, the above-mentioned variables may be set in advance.

In operation S205, the detection device may determine whether a mode operation mod of i and Ncal is 0. For example, the detection device may collect pulse signals until the number of pulse signals reaches Ncal. The collection of pulse signals may include transmitting and receiving a pulse signal, obtaining a mixing signal through mixing, and transforming the mixing signal into a digital domain, according to the above-described example embodiments.

In operation S210, the detection device may set I to 1. In operation S215, the detection device may set m to 1. Operations S210 and S215 are each for the case when the filter compensation data FCD is estimated for a new burst and new M pulse signals.

In operation S220, the detection device may determine whether m is greater than M−1. When m is small, the detection device may increase m and i by 1, respectively. For example, the detection device may collect M pulse signals. The collection of M pulse signals may include selecting M pulse signals from among Ncal pulse signals.

When m is large, the flow proceeds to operation S225 in which the detection device may perform range Doppler Fourier transform on the M pulse signals. Through operation S225, the detection device may obtain Doppler Fourier transform data.

In operation S230, the detection device may perform CFAR on the Doppler Fourier transform data for a plurality of Doppler bins for each range bin. The number of the Doppler bins may be M.

In operation S235, the detection device may select a plurality of samples from among the remaining samples except for a sample, in which a detection flag indicates a specific value, through CFAR in the Doppler Fourier transform data. The number of the selected samples may be K.

In operation S240, the detection device may calculate a sum value of the K samples. For example, the detection device may sum the squares of values of the plurality of samples for an Ith burst, among a plurality of bursts, for each range bin.

In operation S245, the detection device may update a first sum value based on the summation for each burst. For example, the first sum value for the Ith burst may be updated by adding the first sum value calculated in operation S240 to all of the sum values for previous bursts, including the I−1-th burst.

In operation S250, the detection device may determine whether I is greater than L−1. When I is smaller than L−1, the detection device may increase I and i by 1, respectively. Then, the detection device may perform operation S215 to S250 again on the M pulse signals defined as a I+1-th burst. By repeatedly performing operations S215 to S250 until I becomes greater than L−1, the detection device may obtain a second sum value updated for all L bursts.

In operation S255, the detection device may obtain a value, obtained by dividing the obtained second sum value by K*L, as noise power data. For example, the detection device may obtain a variance value for samples of the L bursts as the noise power data.

In the above-described example embodiments, the detection device may obtain the noise power data based on L bursts, rather than a single burst, to improve reliability, and thus may improve the accuracy of the noise power data.

In operation S260, the detection device may estimate a reciprocal of the noise power data, obtained through operation S255, as the filter compensation data FCD. For example, when the noise power data is [p_{1,n}, p_{2,n}, . . . , p_{Ns,n}]^{T}, the detection device may estimate [1/p_{1,n}, 1/p_{2,n}, . . . , 1/p_{Ns,n}]^{T}, calculated as an elementwise inverse, as the filter compensation data FCD.

In operation S265, the detection device may update the filter compensation data FCD through use of weights applied to reference filter compensation data FCD and the filter compensation data FCD, respectively. The reference filter compensation data FCD may be a value estimated before the estimated filter compensation data FCD. The weights may be set to various values. The filter compensation data FCD may be updated in consideration of both newly calculated filter compensation data FCD and the reference filter compensation data FCD to achieve more robust estimation of the filter compensation data FCD.

In operation S270, the detection device may determine whether to re-estimate the filter compensation data FCD. When the filter compensation data FCD is re-estimated, operations S205 to S265 may be repeatedly performed. The re-estimation may be performed on new Ncal pulse signals.

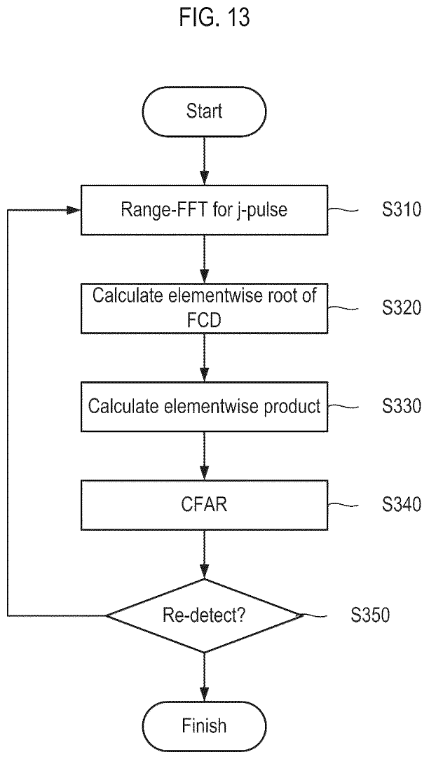

FIG. 13 is a flowchart illustrating a detection method of a detection device according to example embodiments.

Referring to FIG. 13, in operation S310, the detection device may perform a range Fourier transform on a jth pulse signal (where j is a positive integer) based on filter compensation data. Range Fourier transform data for the jth pulse signal may be obtained through range Fourier transform processing.

In operation S320, the detection device may perform an elementwise root operation on the filter compensation data. For example, when the filter compensation data including Ns elements is defined as [f₁, f₂, . . . , f_{Ns}]^{T}, [\sqrt{f₁}, \sqrt{f₂}, . . . , \sqrt{f_{Ns}}]^{T} may be obtained as a result of the elementwise root operation.

In operation S330, the detection device may perform an elementwise product on the result of the root operation obtained in operation S320 and the range Fourier transform data obtained in operation S310.

In operation S340, the detection device may perform CFAR on the result of the elementwise product to detect a target.

Operation S340 is performed on the range Fourier transform data, so that the operational efficiency may be improved compared to performing CFAR on the Doppler Fourier transform data.

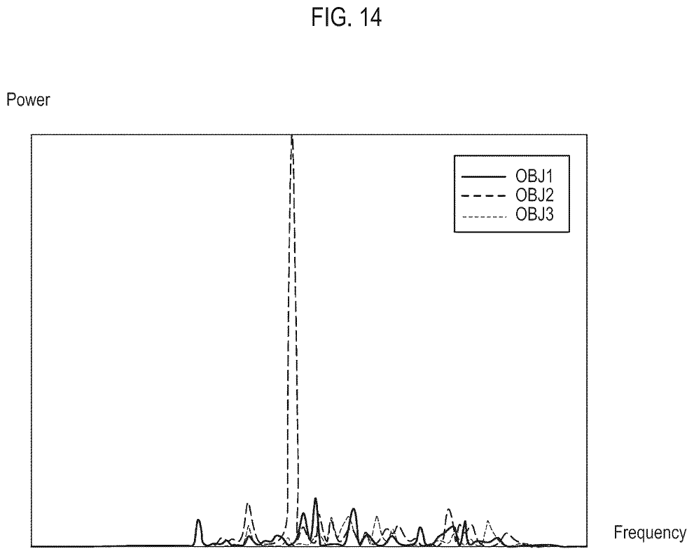

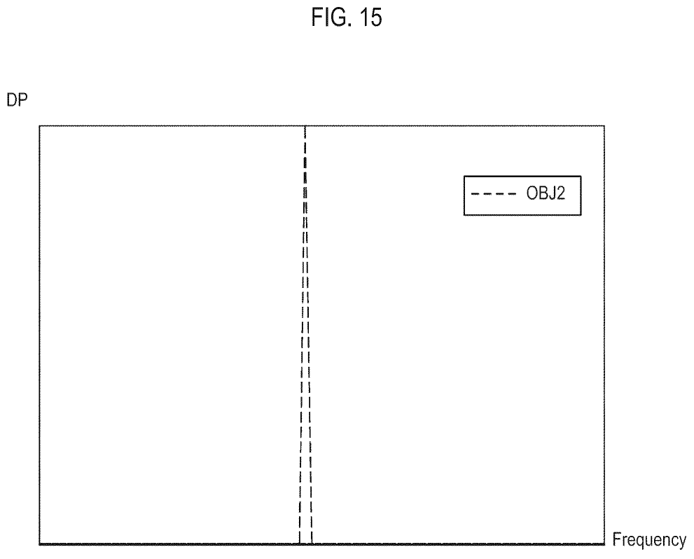

FIG. 14 is a diagram illustrating a range Fourier transform result when there is no compensation for filter characteristics, and FIG. 15 is a diagram illustrating a CFAR result when there is no compensation for filter characteristics.

Referring to FIG. 14, range Fourier transform results for first to third targets OBJ1 to OBJ3 when there is no compensation may show different noise powers for each target. A peak level appears for the second target OBJ2, while only noise power appears for the first and third targets OBJ1 and OBJ3. For example, even when all of the three targets OBJ1 to OBJ3 are present, a peak level only appears for the second target OBJ2.

Referring to FIG. 15, a result of CFAR for FIG. 14 may illustrate that only a detection flag for the second target OBJ2 indicates a specific value, and detection flags for the first and third targets OBJ1 and OBJ3 indicate a logic low level. As a result, the detection device may successfully detect only the second target OBJ2, but fail to detect the remaining targets.

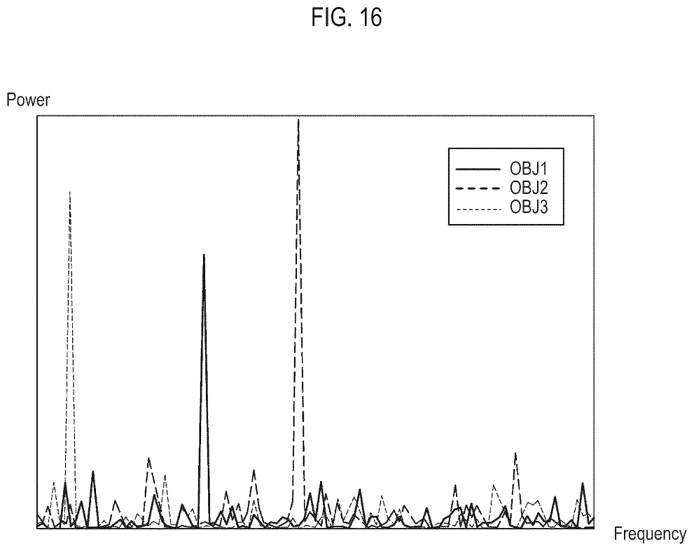

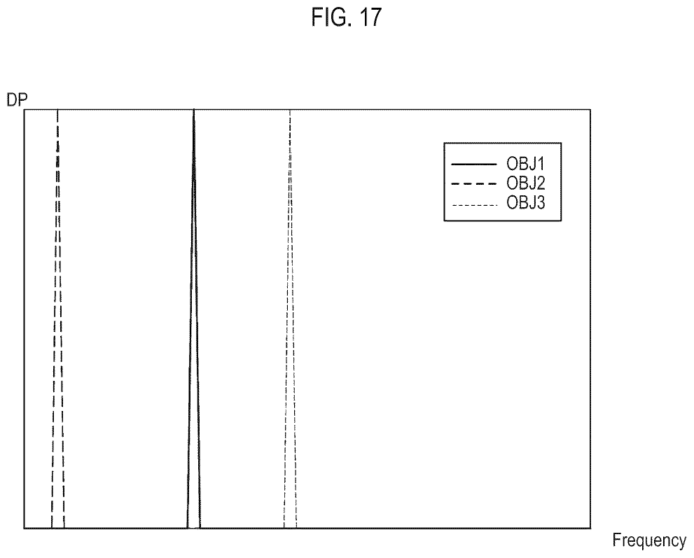

FIG. 16 is a diagram illustrating a range Fourier transform result when there is compensation for filter characteristics according to example embodiments, and FIG. 17 is a diagram illustrating a CFAR result when there is compensation for filter characteristics according to example embodiments.

Referring to FIG. 16, range Fourier transform results for first to third targets OBJ1 to OBJ3 when there is compensation may show peak levels for the targets, and the remaining noise power levels may be similar to each other.

Referring to FIG. 17, a result of CFAR for FIG. 16 may illustrate that detection flags for the first to third targets OBJ1 to OBJ3 all indicate specific values. As a result, the detection device may successfully detect all targets.

As set forth above, according to example embodiments, a detection device robust against to a change in filter characteristics and a method of operating the same may be provided.

While example embodiments have been shown and described above, it will be apparent to those skilled in the art that modifications and variations could be made without departing from the scope of the present inventive concept as defined by the appended claims.

What is claimed is:

1. A detection device comprising:
a Fourier transform processing circuit configured to output first Fourier transform data through range Fourier transform processing on a plurality of pulse signals and output second Fourier transform data through Doppler Fourier transform processing on the first Fourier transform data;
a filter characteristic estimation circuit configured to select a plurality of samples corresponding to noise in the second Fourier transform data through use of a constant false alarm rate (CFAR), obtain noise power data from the plurality of samples, and estimate frequency-dependent filter compensation data based on the noise power data; and
a detection circuit configured to compensate the first Fourier transform data based on the filter compensation data and detect a target based on performing the CFAR on the compensated first Fourier transform data.

2. The detection device of claim 1, wherein the filter characteristic estimation circuit is configured to perform the CFAR on the second Fourier transform data for a plurality of Doppler bins for each range bin.

3. The detection device of claim 1, wherein the filter characteristic estimation circuit is configured to select the plurality of samples from the second Fourier transform data other than those in which a detection flag indicates a specific value, through the CFAR in the second Fourier transform data.

4. The detection device of claim 1, wherein the filter characteristic estimation circuit is configured to obtain a variance value of the plurality of samples as the noise power data.

5. The detection device of claim 1, wherein the noise power data is defined for each frequency.

6. The detection device of claim 1, wherein the filter characteristic estimation circuit is configured to estimate a reciprocal of the noise power data as the filter compensation data.

7. The detection device of claim 1, wherein the filter characteristic estimation circuit is configured to estimate the filter compensation data for a plurality of bursts, each comprising the plurality of pulse signals.

8. The detection device of claim 7, wherein the filter characteristic estimation circuit is configured to:
sum squares of values of the plurality of samples for each range bin, for an Ith burst among the plurality of bursts, where I is a positive integer;
update a first sum value based on the summation for each burst;
obtain a value, obtained by dividing a second sum value, in which the update has been completed for the plurality of bursts, by K*L as the noise power data, where K is a number of the plurality of samples and L is a number of the plurality of bursts.

9. The detection device of claim 1, wherein the filter characteristic estimation circuit is configured to update the filter compensation data through use of weights applied to reference filter compensation data and the filter compensation data, respectively.

10. The detection device of claim 9, wherein the detection circuit is configured to compensate for the first Fourier transform data based on updated filter compensation data.

11. A method of operating a detection device, the method comprising:
outputting first Fourier transform data through range Fourier transform processing on a plurality of pulse signals and outputting second Fourier transform data through Doppler Fourier transform processing on the first Fourier transform data;
selecting a plurality of samples corresponding to noise in the second Fourier transform data through a constant false alarm rate (CFAR) on the second Fourier transform data;
obtaining noise power data from the plurality of samples;
estimating frequency-dependent filter compensation data based on the noise power data;
compensating the first Fourier transform data based on the filter compensation data; and
detecting a target based on performing the CFAR on the compensated first Fourier transform data.

12. The method of claim 11, wherein the selecting the plurality of samples comprises:
performing the CFAR on the second Fourier transform data for a plurality of Doppler bins for each range bin; and
selecting the plurality of samples from among the second Fourier transform data other than those in which a detection flag indicates a specific value, through the CFAR in the second Fourier transform data.

13. The method of claim 11, wherein the noise power data is defined for each frequency.

14. The method of claim 11, wherein the estimating filter compensation data comprises estimating a reciprocal of the noise power data as the filter compensation data.

15. The method of claim 11, further comprising estimating the filter compensation data for a plurality of bursts, each comprising a plurality of pulse signals.

16. The method of claim 15, further comprising:
summing squares of values of the plurality of samples for each range bin, for an Ith burst among the plurality of bursts, where I is a positive integer;
updating a first sum value based on the summation for each burst; and
obtaining a value, obtained by dividing a second sum value, in which the update has been completed for the plurality of bursts, by K*L, as the noise power data, where K is a number of the plurality of samples and L is a number of the plurality of bursts.

17. The method of claim 11, further comprising updating the filter compensation data through use of weights applied to reference filter compensation data and the filter compensation data, respectively.

18. A detection device comprising:
a transceiver configured to transmit and receive a plurality of pulse signals; and
a processor electrically connected to the transceiver,
wherein the processor is configured to:
select a plurality of samples corresponding to noise in Doppler Fourier transform data of the plurality of pulse signals through a constant false alarm rate (CFAR) on the Doppler Fourier transform data;
obtain noise power data from the plurality of samples;
estimate frequency-dependent filter compensation data based on the noise power data;
compensate range Fourier transform data of the plurality of pulse signals based on the filter compensation data; and
detect a target based on performing the CFAR on the compensated range Fourier transform data.

19. The detection device of claim 18, wherein the processor is configured to estimate a reciprocal of the noise power data as the filter compensation data.

20. The detection method of claim 18, wherein the processor is configured to update the filter compensation data through use of weights applied to reference filter compensation data and the filter compensation data, respectively.
